(19) United States
(12) Patent Application Publication
(10) Pub. No.: US 2025/0035848 A1
(43) Pub. Date: Jan. 30, 2025

(54) ENHANCED BACK-SCATTERING FIBER-OPTIC NETWORKS

(71) Applicant: OFS Fitel, LLC, Norcross, GA (US)

(72) Inventors: Kenneth S Feder, Murray Hill, NJ (US); Tristan Kremp, Somerset, NJ (US); Paul S Westbrook, Basking Ridge, NJ (US)

(73) Assignee: OFS Fitel, LLC, Norcross, GA (US)

(21) Appl. No.: 18/711,717

(22) PCT Filed: Oct. 12, 2022
(86) PCT No.: PCT/US2022/046353

§ 371 Date: May 20, 2024

Related U.S. Application Data
(60) Provisional application No. 63/281,643, filed on Nov. 20, 2021.
(60) Provisional application No. 63/352,823, filed on Jun. 16, 2022.

(51) Int. Cl. G02B 6/27; H04B 10/2537

(52) U.S. Cl. CPC G02B 6/2746; H04B 10/2537

(57) ABSTRACT

A system comprising an enhanced back-scattering region, which is confined to a limited enhanced scattering bandwidth (e.g., approximately ten decibel (10 dB) scattering bandwidth over approximately fifteen nanometer (15 nm) wavelength range in the C-Band (Conventional Band)). A signal transmission wavelength (or telecom signal wavelength) carries an optical signal at a wavelength that is at least one nanometer (1 nm) outside of the enhanced scattering bandwidth.

### CROSS REFERENCE TO RELATED APPLICATIONS

This application claims the benefit of U.S. provisional patent application Ser. No. 63/281,643, filed 2021 Nov. 20, with inventor Westbrook, and having the title “Systems, Methods, and Assemblies for Enhanced Back-scattering Fiber in Telecom Networks,” and U.S. provisional patent application Ser. No. 63/352,823, filed 2022 Jun. 16, with inventor Westbrook, and having the title “Enhanced Back-scatter Fibers for Sensing in Telecom Network,” which are incorporated herein by reference in their entireties.

### BACKGROUND

### Field of the Disclosure

The present disclosure relates generally to fiber optics and, more particularly, to fiber optic networks.

### Description of Related Art

Conventional wisdom teaches that scattering (such as Rayleigh scattering) in an optical fiber degrades a telecommunication signal, thereby imposing a penalty on signal quality. Thus, to improve signal quality and reach (i.e., effective transmission length of a particular optical channel) in optical fibers, the art normally teaches away from increased scattering.

### SUMMARY

The present disclosure provides systems and methods associated with enhanced back-scattering fibers in telecommunications networks.

Briefly described, in architecture, one embodiment of a system comprises an enhanced back-scattering region, which is confined to a limited enhanced scattering bandwidth. A signal transmission bandwidth (or telecom signal bandwidth) carries an optical signal at one or several wavelengths that are at least one nanometer (1 nm) outside of the enhanced scattering bandwidth.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a graph illustrating effects of multipath interference (MPI) and attenuation in one embodiment of an enhanced back-scattering fiber.

FIG. 1B is a graph showing extension of fiber reach for one embodiment of an enhanced back-scattering fiber.

FIG. 2 is a block diagram illustrating MPI in a distributed sensing system.

FIG. 3 is a graph showing reflected signal power (P_{signal,dB}(z)) for one embodiment of a bare fiber.

FIG. 4 is a graph showing P_{signal,dB}(z) for one embodiment of an enhanced back-scattering fiber.

FIG. 5A is a block diagram showing one embodiment of a telecommunication system with an enhanced back-scattering fiber.

FIG. 5B is a graph showing optical time domain reflectometry (OTDR) power plotted as a function of fiber length for one embodiment of an enhanced back-scattering fiber.

FIG. 5C is a graph showing reflection and optical signal-to-noise ratio (OSNR) penalty at various wavelengths for one embodiment of an enhanced back-scattering fiber.

### DETAILED DESCRIPTION OF THE EMBODIMENTS

Distributed acoustic sensing (DAS) is emerging as an important new tool to monitor large linear assets, such as oil and gas facilities, security systems, rail lines, pipelines, and so on. DAS has also been used to transform telecommunications systems (or telecom systems) into distributed sensors that can detect disturbances (e.g., traffic, construction, earthquakes, etc.) near a transmission line. Consequently, DAS has the potential to provide information about the health of telecom networks as well as the infrastructure in which they are employed.

DAS has been enabled by a new generation of coherent optical time domain reflectometry (OTDR) interrogators. A coherent OTDR interrogator measures distributed back-scattering of an optical pulse that propagates through an optical fiber. Unlike conventional OTDR techniques that are commonly used to assess telecom networks, coherent OTDR employs narrow linewidth, low phase noise lasers as inputs to the OTDR. Additional phase and amplitude modulators reduce various fading artifacts to permit a more robust signal output.

Acoustic signals change the optical path along the fiber due to compression of the silica matrix from the acoustic wave, which makes the optical length along the fiber vary from one OTDR pulse to the next. Comparing successive traces permits recording of acoustic wave propagation along the length of the fiber, with typical spatial resolutions being a few meters (m) and an acoustic frequency range typically being in the range of millihertz (mHz) to kilohertz (kHz).

One example limitation of such systems is their reliance on Rayleigh back-scattering to generate coherent OTDR traces. In typical low-loss fibers, Rayleigh back-scattering is on the order of 5·10⁻⁸/m or 5·10⁻¹¹/mm, which is often referred to as −73 decibels-per-meter (dB/m) or −103 decibels-per-millimeter (dB/mm) of fiber, due to 10·log₁₀(5·10⁻⁸) being −73 and 10·log₁₀(5·10⁻¹¹) being −103, respectively. The weakness of the back-scattered signal limits various DAS parameters, such as spatial resolution, acoustic signal-to-noise ratio (SNR), system reach, and frequency response.

To address this type of limitation, and to increase both optical SNR (OSNR) and acoustic SNR (sometimes by more than an order of magnitude), predefined lengths of enhanced back-scattering fibers are used, which exhibit spatially continuous quasi-Rayleigh back-scattering over a well-defined bandwidth and have background attenuations that are below 0.5 dB per kilometer (km). In some examples, these predefined lengths of enhanced scattering fibers (e.g., a few km in length) have completely restored the DAS signal, even after attenuation for more than 40 km of telecom fiber. Those having skill in the art understand fully what is meant by “enhanced back-scattering fiber” (see, e.g., Westbrook et al., “Enhanced Optical Fiber for Distributed Acoustic Sensing Beyond the Limits of Rayleigh Back-scattering,” iScience, 23(6), p. 101137 (2020); Lalam et al., “Phase-Sensitive Optical Time Domain Reflectometry with Rayleigh Enhanced Optical Fiber,” IEEE Access, 9, pp. 114428-114434 (2021); Wellbrock, et al., “Perimeter Intrusion Detection with Back-scattering Enhanced Fiber Using Telecom Cables as Sensing Backhaul,” In Optical Fiber Communication Conference (pp. M2F-5), Optica Publishing Group (2022)). Consequently, only truncated descriptions of enhanced back-scattering fibers are provided for context. Also, throughout this disclosure, unless expressly indicated otherwise or by context, enhanced back-scattering fiber is also designated as “enhanced scattering fiber” or “enhanced fiber” for simplicity.

Continuing, although these limited lengths (e.g., a few kilometers (km)) of enhanced scattering fibers have been shown to be effective to (at least partially) restore DAS signals, what is neither intuitive nor obvious is whether continuously enhanced scattering fibers with lengths that are suitable for telecom applications (e.g., several tens of kilometers) can carry acceptable telecom signals. This is because telecom applications are remarkably different from oil-field monitoring applications (or other contexts in which DAS has been employed). For example, in fiber telecom, the lengths of optical fibers are much longer, thereby introducing issues that do not overlap completely with other monitoring applications. Typical sensors for seismic monitoring are only a few kilometers and benefit from very large signal enhancements over the sensitive portion of the fiber. In telecom, however, transmission lengths frequently exceed 40 km, thereby requiring consideration of attenuation, potential multipath interference (MPI), cross-talk, or other issues that are important to telecommunications.

In telecom applications, it is also important to consider whether an entire span requires enhanced scattering or whether enhanced scattering should be limited to specific regions within the span where the DAS signal is low. For instance, in passive optical networks (PONs), large attenuation occurs at optical splitters, but structures of interest in sensing applications are often located in the transmission pathway after the optical splitter. Additionally, the concept of reach in a distributed sensor system is not the same as the concept of reach in optical fiber communication systems. In telecom, reach is determined by the integrity of the signal at the end of the span (at the terminal receiving end of the pathway) when the signal is launched only at the beginning of the span. By comparison, in distributed sensing, signal is acquired from the entire length of the fiber and, thus, it is important to consider signal enhancement over the entire length of the fiber, even though the interrogator, like the receiver in a telecom system, is located at only one single discrete position.

To be clear, unlike conventional sensing applications (for which it is desirable to increase the length over which distributed sensing can occur, even at the expense of higher attenuation), this disclosure seeks to increase SNR over long fiber spans that are suitable for telecom applications. To do so, it is necessary to understand the effect of the enhanced back-scattering on telecom signals. For example, it is well known that MPI noise can arise from the effect of double Rayleigh back-scattering on telecom signals (which is undesirable). Thus, in fibers with continuously enhanced back scattering, such undesirable effects are expected to increase with increasing Rayleigh-like back-scattering enhancements.

To mitigate the undesirable effects, some embodiments of the disclosed systems confine the enhanced back-scattering to a certain range of wavelengths (or limited bandwidths), with the telecom signal being carried and propagated outside of the scattering bandwidth. In preferred embodiments, a telecommunication signal carrier wavelength is at least one nanometer (1 nm) outside of a 10 dB scattering bandwidth, which results in a negligible OSNR penalty on the telecom signal. In finding a preferred range for transmitting a desired signal and confining enhanced back scattering to a well-defined bandwidth, this disclosure also measures OSNR penalties associated with signals that propagate within the scattering bandwidth and, further, characterizes the effects of the scattering bandwidth on actual telecom signals. To be clear, some embodiments include more than one enhanced-scattering bandwidth at multiple different or overlapping portions of the optical fiber. As one can appreciate from this disclosure, even for optical fibers with a single enhanced-scattering bandwidth, that bandwidth can be centered at different wavelengths, as well as having different wavelength ranges (or different bandwidths). Furthermore, those having skill in the art will appreciate that this disclosure also contemplates a PON with a splitter with enhanced-scattering fibers after the splitter. Other similar variants or configurations are also contemplated within the scope of this disclosure.

Having provided a broad technical solution to a technical problem (namely, confining the back-scattering bandwidth and positioning the telecom signal at least mm outside of the 10 dB scattering bandwidth), reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

If a transmission axis in an enhanced scattering fiber is designated as the z-axis, back-scattered signal power at location z is represented by:

$${P}_{signal} ( z ) = {P}_{in} {ρ}_{e} Δ {ze}^{- 2 {α}_{e} z} , \qquad [ Eq . 1 ] ,$$

where Pᵢₙ is the input power, ρₑ is the reflectivity per unit length (taking into account enhanced back-scatter), Δz is the length of fiber giving rise to the back-scatter, and αₑ is the fiber attenuation per unit length. To understand the effect of back-scatter enhancement, the signal is normalized to the back-reflected power at z=0. When only Rayleigh scattering is present, with ρ_{R} representing the back reflection per unit length for Rayleigh scattering, the back-scattered signal power at z=0 is:

$${P}_{R} ( 0 ) = {P}_{in} {ρ}_{R} Δ z , \qquad [ Eq . 2 ] .$$

For bare fibers that have additional scattering losses beyond Rayleigh scattering, ρ_{R} can also represent back-scattering per unit length before any treatments are applied to increase back-scattering. As one can appreciate, typically, ρₑ≥ρ_{R}. Insofar as Rayleigh scattering is from an incoherent sum of scatterers, the power of Rayleigh back-scattering scales with the length of back-scattering fiber. Representing signal power relative to Rayleigh scattering at z=0 in decibel (dB) form:

$$\begin{matrix}{P}_{signal , dB} ( z ) := 10 {log}_{10} \frac{{P}_{signal} ( z )}{{P}_{R} ( 0 )} \\ = 10 {log}_{10} \frac{{P}_{in} {ρ}_{e} Δ {ze}^{- 2 {α}_{e} z}}{{P}_{in} {ρ}_{R} Δ z} \\ = 10 {log}_{10} \frac{{ρ}_{e} {e}^{- 2 {α}_{e} z}}{{ρ}_{R}} \\ = {R}_{e , dB} - 2 {α}_{e , dB} z\end{matrix} , \qquad [ Eq . 3 ] .$$

where α_{e,dB}=10 log₁₀(e)αₑ is the fiber attenuation in dB per unit length and R_{e,dB}=10 log₁₀(ρₑ/ρ_{R}) is the back-scatter enhancement in dB per unit length relative to bare fiber scattering (which is typically dominated by Rayleigh scattering in low-loss fibers that are usually found in telecom systems). As one can see, if only Rayleigh scattering is present, then ρₑ=ρ_{R} and R_{e,dB}=0 dB.

Maximum reach for a sensor based on an enhanced back-scattering fiber is represented by:

$${z}_{reach , attenuation} = \frac{{R}_{e , dB} - {P}_{min , dB}}{2 {α}_{e , dB}} , \qquad [ Eq . 4 ] ,$$

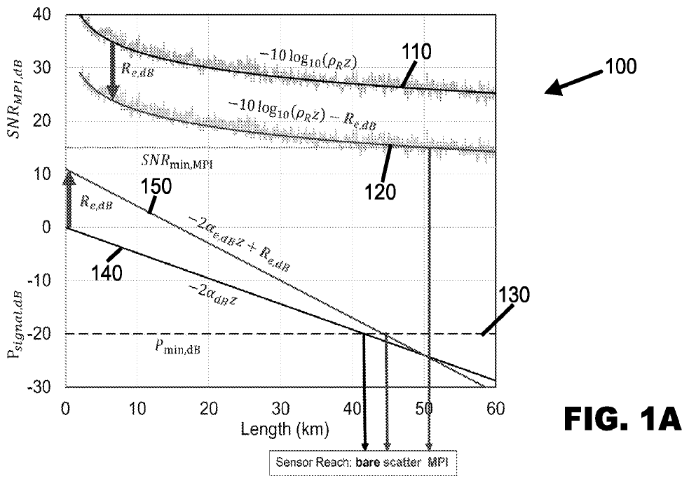

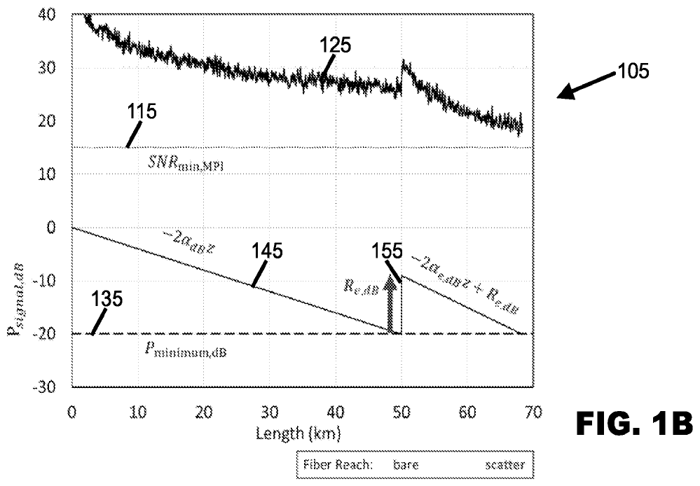

with P_{min,dB} being a minimum signal power level for effective DAS measurements, with P_{min,dB} depending on Δz. The bottom of FIG. 1A shows one example embodiment illustrating the Δz dependence of P_{min,dB}. FIG. 1A also illustrates the effects of MPI and attenuation in one embodiment of an enhanced back-scattering fiber.

Specifically, FIG. 1A shows R_{e,dB}=11 dB, with a bare fiber 110, 140 compared to an enhanced back-scattering fiber 120, 150. SNR_{MPI,dB}=10 log₁₀(|E₁|/|E_{MPI}|) represents the SNR in dB, with E_{MPI} representing the MPI contribution to reflected E-field and E₁ representing the reflected E-field in the absence of MPI. In the embodiment 100 of FIG. 1A, the bare fiber attenuation is shown as being α_{dB}=0.24 dB/km and the enhanced back-scattering fiber attenuation is shown as being α_{e,dB}=0.35 dB/km.

For the particular embodiment 100 of FIG. 1A, minimum required power level 130 is defined as −20 dB relative to the input power and the minimum required value of SNR_{MPI,dB} is set at 15 dB. The minimum SNR and power level permit calculations of sensor reach based on attenuation and MPI. As shown in FIG. 1A, when the back-scattering enhancements increase, the MPI and attenuation curves move in opposite directions. Noteworthy is the fact that the reflectivity (ρₑ) observed in the enhanced back-scattering fiber is larger than the reflectivity (ρ_{R}) observed in the bare fiber over the length of the entire fiber.

As shown in FIG. 1B (which is a graph 105 showing extension of fiber reach 155 for one embodiment of an enhanced back-scattering fiber), the reach can be extended by adding an enhanced scattering fiber at z_{reach,attenuation} to an existing length of standard fiber with R_{e,dB}=0 dB. Again, both the effects of the bare fiber 145 and the enhanced fiber 155 are shown with P_{min,dB} 135 being set to −20 dB. Also, SNR 125 along the length of the transmission pathway is shown, with SNR_{min,MPI} 115 being set to 15 dB. The extension of reach (z_{reach extension}) is represented as:

$${z}_{reach extension} = \frac{{R}_{e , dB}}{2 {α}_{e , dB}} , \qquad [ Eq . 5 ] .$$

One of the primary goals in telecom systems is to maximize reach. Thus, as shown from the combination of Eqs. 4 and 5, when desired or acceptable values for P_{min,dB} and SNR_{min,MPI} are provided (as shown in FIGS. 1A and 1B (collectively, FIG. 1)), appropriate values for R_{e,dB} and α_{e,dB} are used to calculate a maximum reach. If R_{e,dB} and α_{e,dB} vary linearly along the length of a fiber, then maximum reach is computable from four (4) parameters, namely, R_{e,dB}, the slope of R_{e,dB}, α_{e,dB}, and the slope of α_{e,dB}. Because maximization and minimization methods are known to those having ordinary skill in the art, discussions of how to compute maximum and minimum values are omitted herein. Specifically, when a signal in an existing optical fiber has dropped to P_{min,dB}, adding an enhanced scattering fiber to the existing optical fiber of length z_{reach extension} (from Eq. 5) will provide an extension in reach that is proportional to R_{e,dB} and inversely proportional to α_{e,dB} in the added enhanced scattering fiber, as shown in FIG. 1B.

In some embodiments, for an enhanced back-scattering fiber with a 10 dB enhanced scattering bandwidth over a 15 nm wavelength range, signals that are 1 nm outside of the enhanced scattering bandwidth can be transmitted with less than a 1 dB penalty in OSNR.

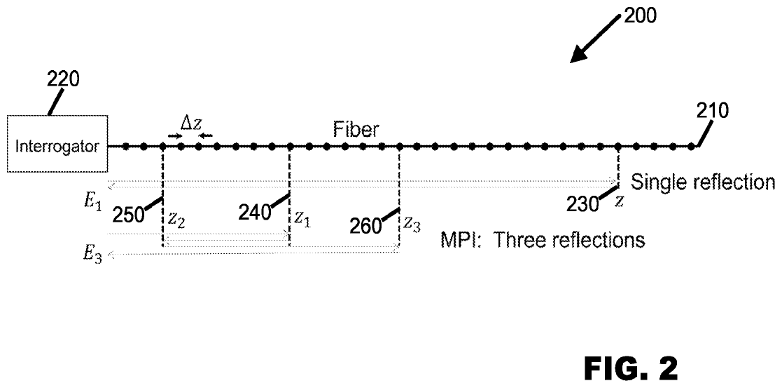

In addition to attenuation, another limitation in reach comes from MPI or crosstalk from multiple reflections before z. As enhanced scattering (or enhancement) increases, MPI correspondingly increases, thereby degrading DAS signal quality. Effects of MPI have been considered previously for fiber arrays with discrete reflectors, including reflective splices, fiber loop mirrors, and discrete fiber Bragg gratings (FBGs). As an approximation, continuously enhanced scattering fibers are modeled as a set of discrete reflectors. FIG. 2 is a block diagram illustrating MPI in a distributed sensing system 200 (modeling continuous enhancements as multiple, discrete reflectors). Specifically, the distributed sensing system 200 comprises an optical fiber 210 that is optically coupled to an interrogator 220.

According to the model of FIG. 2, a single reflection point 230 is located at a distance of z, with N reflection points (shown as dots) that are distributed evenly along the fiber and each separated from its nearest neighbor by Δz. Three (3) reflection points z₁ 240, z₂, 250, and z₃ 260 are chosen to illustrate the effects of MPI, with E₁ and E₃ being example E-fields that represent an intensity of a returned signal to the interrogator 220.

MPI depends on the total reflectivity of the fiber 210, with the total average single-reflection reflectivity (assuming no attenuation and constant reflectivity per unit length at each reflection point) being:

$${R}_{total , 0} ( z ) = ρ z = ρ N Δ z , \qquad [ Eq . 6 ] ,$$

with ρ representing the reflectivity per unit length, z representing the position along the fiber, and N representing the total number of reflection points along the fiber. More generally, average reflectivity Rₜₒₜₐₗ(z) is represented by:

$${R}_{total} ( z ) = {\int }_{0}^{z} ρ ( {z}^{′} ) {e}^{- 2 {\int }_{0}^{{z}^{′}} α ( {z}^{″} ) {dz}^{″}} {dz}^{′} , \qquad [ Eq . 7 ] ,$$

where ρ(z) represents reflectivity per unit length and α(z) represents attenuation, both of which can vary along the length of the fiber. When both ρ(z) and α(z) are constant, then Eq. 7 simplifies to:

$${R}_{total} ( z ) = {R}_{total , 0} ( z ) \frac{( 1 - {e}^{- 2 α z} )}{2 α z} , \qquad [ Eq . 7 a ] .$$

To measure MPI independently of a particular DAS interrogation scheme, MPI is computed using the ratio of the reflected electric field E₁ (in FIG. 2) in the absence of MPI to the E_{MPI} from multiple bounces (e.g., E₃ in FIG. 2). By using the ratio of E₁ to other E_{MPI}, a relationship between fiber length, scatter enhancement, and average ratio of signal to MPI noise is provided. The effects of MPI in long lengths of fiber with continuous or quasi-continuous enhanced back-scattering is compared to the effects of attenuation. Also, a lowest-order approximation of MPI is compared to a full solution for MPI, which shows that the lowest-order approximation of MPI provides an adequate estimate of the full MPI solution.

The lowest-order contribution to MPI arises from three (3) reflections. The relative electric field amplitude from a single reflection (or bounce) at position z is:

$${ε}_{1} ( z ) = \sqrt{ρΔ z} {e}^{i ϕ ( z ) - α z} = q ( z ) Δ {ze}^{- α z} , \qquad [ Eq . 8 ] ,$$

where ε(z)=E(z)/Eᵢₙ, with Eᵢₙ=√Pᵢₙ being the magnitude of the input E-field, ϕ(z) being the relative optical phase of light scattered at position z, and the complex-valued reflection coefficient being represented by:

$$q ( z ) = \sqrt{ρ / Δ z} {e}^{i ϕ ( z )} , \qquad [ Eq . 8 a ] .$$

Because all MPI paths arrive (by definition) at the same time, if attenuation is independent of the position z and the dispersion is negligible (meaning, group velocity equals phase velocity), then the ratio of single and triple scattering remains unaffected. In other words, the effect of MPI remains unaffected by a constant attenuation.

The scattering from position z in the fiber is modeled as a discrete sum over N=z/Δz discrete scatters. The three (3) locations for the three-bounce scatter are at zⱼ=Δz·iⱼ for integer numbers of iⱼ≤N and j∈{1,2,3}. For a single bounce at location z, the total path length (forward and backward) is 2z. Consequently, for three (3) bounces at z₁, z₂, and z₃, the total path length is z₁+(z₁−z₂)+(z₃−z₂)+z₃=2(z₁−z₂+z₃). If z=z₁−z₂+z₃, then N=i₁−i₂+i₃ and ε₃(z) can be written as:

$${( ρΔ z )}^{\frac{3}{2}} {\sum }_{{i}_{1} = 1}^{N} {e}^{i ϕ ( {z}_{{i}_{1}} )} {\sum }_{{i}_{2} = 1}^{{l}_{1}} {e}^{i [ - ϕ ( {z}_{{i}_{2}} ) + ϕ ( {z}_{N - {i}_{1} + {i}_{2}} ) ]} , \qquad [ Eq . 9 ] .$$

When the reflection magnitudes are all presumed to be the same, the two sums in Eq. 9 can be re-written as a single sum of N²/2 phasors that describe all possible triple-bounce paths. Also, if all phases are uncorrelated, then the expected value of |ε₃(z)| of the modulus of Eq. 9 scales as the square root of their number, or (N²/2)^{1/2}=N/√2, because the modulus of the sum of a circular uniform distribution has a Rayleigh distribution in the mathematical sense.

When some of the N²/2 phases are correlated (because exchanging z₁ and z₃ in FIG. 2 corresponds to two (2) different triple-bounce paths with an identical phasor product), the factor of 1√2 becomes a factor η of the order of 1 and, thus, Eqs. 6 and 9 become:

$$\overline{\vert {ε}_{3} ( z ) \vert} = {η ( ρΔ z )}^{\frac{3}{2}} N = {η ( ρΔ z )}^{\frac{1}{2}} {R}_{total , 0} ( z ) , \qquad [ Eq . 10 ] ,$$

which shows that (in the absence of attenuation) MPI from signals with a path length of 2z will scale with the total power that is reflected up to z. Based on Eqs. 6 and 10, SNR defined as the ratio of single-bounce-to-triple-bounce E-fields is expressed as:

$$\begin{matrix}S N {R}_{MPI , dB} = 10 {log}_{10} \frac{\overline{\vert {ε}_{1} ( z ) \vert}}{\overline{\vert {ε}_{3} ( z ) \vert}} \\ = 10 {log}_{10} \frac{\sqrt{ρΔ z}}{η \sqrt{ρΔ z} {R}_{total , 0} ( z )} \\ = - 10 {log}_{10} η \frac{ρ}{{ρ}_{R}} {ρ}_{R} z \\ = - 10 {log}_{10} {ηρ}_{R} z - {R}_{e , dB}\end{matrix} , \qquad [ Eq . ll ] .$$

As shown in FIG. 1A, the enhancement decreases this E-field ratio SNR_{MPI,dB} by the same amount R_{e,dB} that the back-scattering intensity increases.

The sensor reach due to MPI can then be related to the minimum tolerable level of MPI (denoted by SNR_{min,MPI}), with reach being expressed as:

$${z}_{reach , MPI} ∼ ( \frac{1}{{ρ}_{R}} ) {10}^{- \frac{S N {R}_{min , MP1} + {R}_{e , dB}}{10}} , \qquad [ Eq . 12 ] .$$

As one having ordinary skill in the art will be able to appreciate, for given values of P_{min,dB} and SNR_{min,MPI}, there exist values of R_{e,dB} and α_{e,dB} such that Eqs. 4 and 12 represent the same value and, also, reach becomes maximized. In other words, a maximum reach is obtained when fiber properties are chosen so that the reach of Eq. 4 (as a function of attenuation) is substantially the same as the reach of Eq. 12 (as a function of MPI). An example of this is shown with reference to FIG. 1A, where the calculated values for Eqs. 4 and 12 are within twenty percent (20%) of each other. Additionally, if there are multiple acceptable values for R_{e,dB} and α_{e,dB}, then these two values (along with their corresponding lengths) can be adjusted to maximize reach.

For interrogation methods that are sensitive to E-field, such as those that interfere the returned signal with a local oscillator, the MPI SNR definition (above) may be appropriate. However, for other interrogation methods that depend on the intensity of the returned signal, the above-recited SNR metric might need to be multiplied by a factor of two in order to relate the power (rather than the E-field amplitudes) of the single and multiple bounce E-fields.

The assumption that triple-bounce effects dominate MPI, while higher orders (e.g., 5 bounces, 7 bounces, etc.) are negligible, can be demonstrated by solving coupled-mode equations (CMEs) for continuous reflections along an optical fiber. Specifically, with the reflection coefficient q(z) from Eq. 8 and group velocity, v_{g}, the time-domain CME for forward-propagating E-field, E_{f}, and backward propagating E-field, E_{b}, are (with asterisk symbol, *, denoting a complex conjugation) expressed as:

$$\frac{1}{{v}_{g}} \frac{\partial }{\partial t} ( \begin{matrix}{E}_{b} ( z , t ) \\ {E}_{f} ( z , t )\end{matrix} ) = ( \begin{matrix}- \frac{α}{2} + \frac{\partial }{\partial z} & - q ( z ) \\ {q}^{*} ( z ) & - \frac{α}{2} - \frac{\partial }{\partial z}\end{matrix} ) ( \begin{matrix}{E}_{b} \\ {E}_{f}\end{matrix} ) , \qquad [ Eq . 13 ] ,$$

which is a consequence of Maxwell's Equations under the presumption that |q|<<2π/λ (where λ represents the operating wavelength of the system), which reasonably approximates the enhancement levels, R_{e,dB}, and discretization grid sizes, Δz. By setting t=2z/v_{g} and maintaining the notation from above, E(z) becomes E_{b}(0.2z/v_{g}) and ε(z)=E(z)/Eᵢₙ=E_{b}(0.2z/v_{g})/Eᵢₙ.

When off-diagonal (reflection) and on-diagonal (propagation) components of Eq. 13 are separated, an approximate solution using temporal transfer matrices is:

$$( \begin{matrix}{E}_{b} ( z - Δ z , t + \frac{Δ z}{{v}_{g}} ) \\ {E}_{f} ( z + Δ z , t + \frac{Δ z}{{v}_{g}} )\end{matrix} ) = {e}^{- α ( z ) Δ z / 2} ( \begin{matrix}C ( z ) & - S ( z ) \\ {S}^{*} ( z ) & C ( z )\end{matrix} ) ( \begin{matrix}{E}_{b} ( z , t ) \\ {E}_{f} ( z , t )\end{matrix} ) , \qquad [ Eq . 14 ] ,$$

with:

$$C ( z ) = cos ( \vert q ( z ) \vert Δ z ) , \qquad [ Eq . 14 a ] ,$$

and:

$$S ( z ) = \frac{q ( z ) sin ( \vert q ( z ) \vert Δ z )}{\vert q ( z ) \vert} , \qquad [ Eq . 14 b ] .$$

Insofar as even bounces (e.g., 0, 2, 4, 6, etc.) represent forward scattering and odd bounces (e.g., 1, 3, 5, 7, etc.) represent backward scattering, Eq. 14 includes all bidirectional scattering orders (meaning, any number of bounces). It should be noted that higher reflection orders (3, 5, 7, etc.) correspond to sensor MPI, while the first order (meaning, single bounce) represents the unperturbed signal that is subject to the single-bounce CME solution (or first Born approximation) that has a vanishing off-diagonal element in the forward direction:

$$( \begin{matrix}{E}_{b}^{( 1 )} ( z - Δ z , t + \frac{Δ z}{{v}_{g}} ) \\ {E}_{f}^{( 1 )} ( z + Δ z , t + \frac{Δ z}{{v}_{g}} )\end{matrix} ) = {e}^{- α ( z ) Δ z / 2} ( \begin{matrix}C ( z ) & - S ( z ) \\ 0 & C ( z )\end{matrix} ) ( \begin{matrix}{E}_{b}^{( 1 )} ( z , t ) \\ {E}_{f}^{( 1 )} ( z , t )\end{matrix} ) , \qquad [ Eq . 15 ] .$$

Eq. 15 intentionally neglects higher reflection orders and, thus, does not conserve power for vanishing attenuation at α=0. In contrast, if the lower-left element of CME Eq. 13 is set to 0 and the matrix exponential applied, then the resulting transfer matrix would be closer to unitary (or energy-conserving), meaning, the power in higher-order reflections would not be correctly disregarded.

The reflected signal E_{f}⁽¹⁾(0,t) at the proximal end z=0 of the fiber is a superposition of single bounces that occur along the length of the optical fiber. In the case of a launched Dirac impulse, E_{f}⁽¹⁾(0,t)˜δ(t), the back-reflected signal at the proximal end is an attenuated copy of the back-scattering coefficient along the fiber, such that E_{b}⁽¹⁾(0.2z/v_{g})˜q(z)e^{-αz}. Generally, the MPI signal is the difference of the all-bounce solution E_{b}(0,t) from Eq. 13 and the single-bounce signal E_{b}⁽¹⁾(0,t) from Eq. 14, such that:

$${E}_{b , MPI} ( 0 , t ) = {E}_{b} ( 0 , t ) - {E}_{b}^{( 1 )} ( {0}_{,} t ) , \qquad [ Eq . 16 ] .$$

The relative reflected power P_{signal,dB}(z) is:

$$10 {log}_{10} \frac{{\vert {E}_{b} ( 0 , 2 z / {v}_{g} ) \vert}^{2}}{{ρ}_{R} Δ {zP}_{in}} = 10 {log}_{10} \frac{{\vert E ( z ) \vert}^{2}}{{ρ}_{R} Δ {z}_{in}} = 10 {log}_{10} \frac{{\vert ε ( z ) \vert}^{2}}{{ρ}_{R} Δ z} , \qquad [ Eq . 3 a ] ,$$

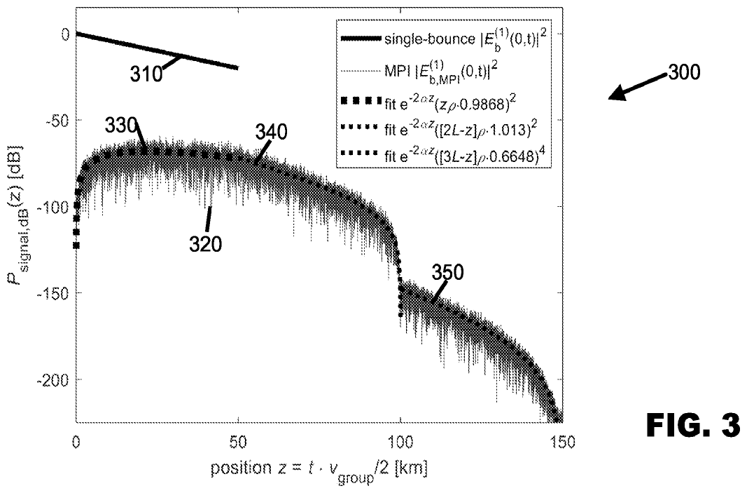

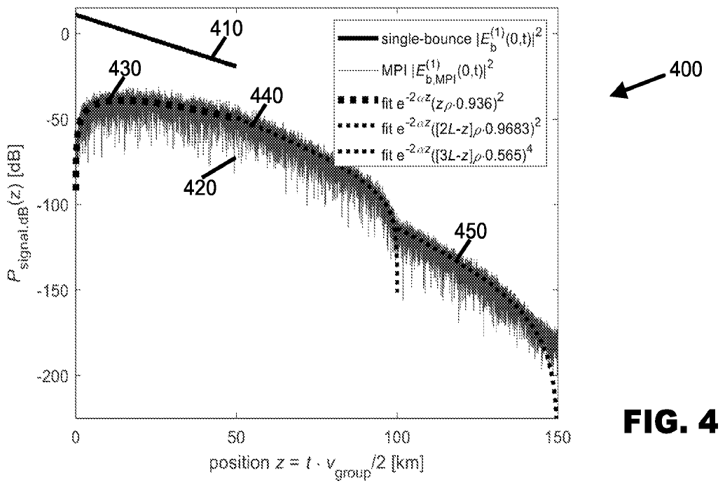

and the reflected signal power (P_{signal,dB}(z)) for one embodiment of a bare fiber is shown in FIG. 3, while P_{signal,dB}(z) for one embodiment of an enhanced back-scattering fiber is shown in FIG. 4. Specifically, FIG. 3 shows plots of a single-bounce reflection 310, MPI 320, and best-fit curves for 0<z<L (labeled as 330), L<z<2L (labeled as 340), and 2L<z<3L (labeled as 350), for a length L=50 km of bare fiber with α_{dB}=0.2 dB/km. For comparison, FIG. 4 shows plots of single-bounce 410, MPI 420, and best-fit curves for 0<z<L (430), L<z<2L (440), and 2L<z<3L (450), for a length L=50 km of enhanced fiber with R_{e,dB}=11 dB, ρ_{R}=5·10⁻⁵/km, and α_{dB}=0.3 dB/km. The MPI from FIGS. 3 and 4 are also shown in FIG. 1A. The agreement with predicted values, |ε₁(z)|²/ρ_{R}=Δze^{-2αz}ρ/ρ_{R}, as compared to the simple triple-bounce equation, Eq. 10, is excellent with example η=0.9868 for the bare fiber and η=0.936 for the enhanced fiber.

FIGS. 3 and 4 also show ghost reflections that result from MPI. For t>2NΔz/v_{g}=2L/v_{g}, meaning that z>L, the MPI level decreases because some MPI reflection locations are beyond the fiber length L. Hence, the MPI level is highest at the end, z=L, and may be obtained from the level of the (ghost) reflection that is just beyond the end of the fiber. As such, the MPI effects can be estimated from an OTDR trace of an optical fiber. For example, if the power of the ghost reflection just beyond the end of the OTDR trace is 20 dB less than the OTDR reflection at the end of the fiber, then the MPI power ratio may be estimated to be 20 dB and the E-field ratio SNR_{MPI,dB} would be 10 dB. As shown in FIGS. 3 and 4, higher-order ghost reflections can be approximated by polynomials. Quantitatively, P_{signal}(z) competes with triple-bounce MPI˜(zρe^{-2αz})² for 0<z<L and ˜([2L−z]ρe^{-2αz})² for L<z<2L and five-bounce MPI˜([3L−z]ρe^{-2αz})² for 2L<z<3L, where proportionality constants are very close to 1, as shown in FIGS. 3 and 4.

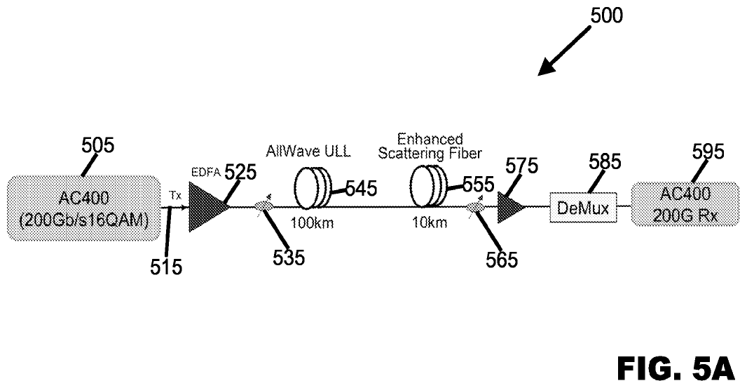

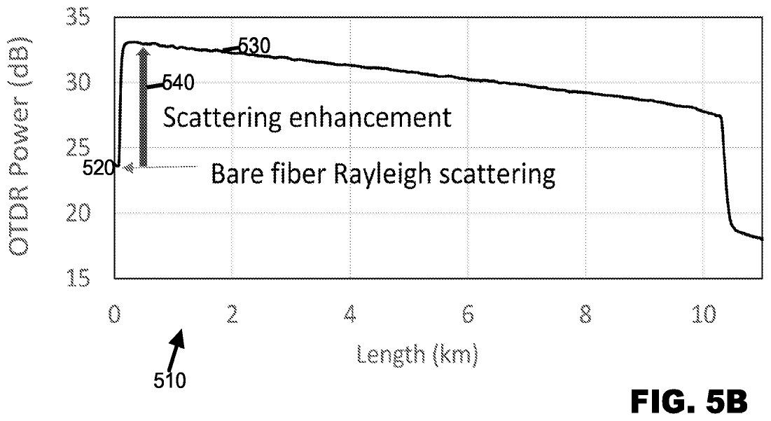

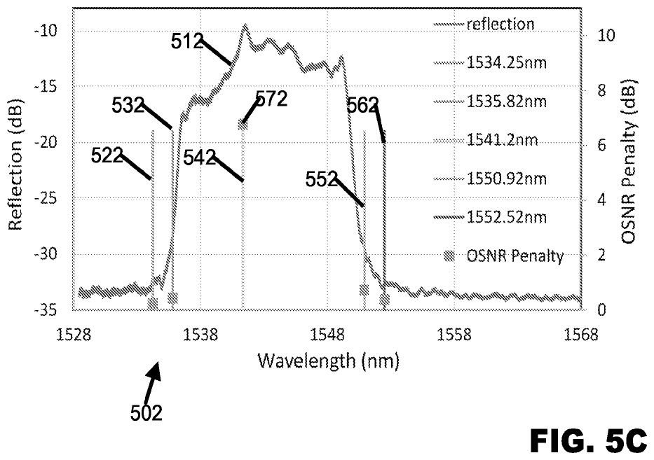

With these sensing properties in mind, this disclosure further teaches embodiments in which enhanced back-scattering fibers carry telecom signals across length scales that are appropriate for telecom applications. To demonstrate the applicability of enhanced back-scattering fibers in telecom environments, an experimental fiber link was configured as shown in FIG. 5A. Specifically, FIG. 5A is a block diagram showing one embodiment of a telecommunication system 500 with an enhanced back-scattering fiber 555 that is optically coupled to an ultra-low-loss (ULL) fiber 545, such as an AllWave® ULL optical fiber, available from OFS Fitel, LLC. Specifically, a 10 km length of enhanced back-scattering fiber 555 is optically coupled to 100 km of ULL fiber, thereby representing a realistic transmission length of 110 km for a telecommunication fiber link. It should be appreciated that, for other embodiments, the enhanced back-scattering fiber 555 can be anywhere between approximately 1 km in length to the length of the entire telecommunication fiber link.

Also, while the enhanced back-scattering fiber 555 is shown to be optically coupled to the receiver end of the telecom optical fiber 545, it should be appreciated that for other embodiments the enhanced back-scattering fiber 555 is optically coupled to the transmitter end of the telecom optical fiber 545, while for yet other embodiments, the enhanced back-scattering fiber 555 is optically coupled anywhere in the span of the telecom optical fiber 545. In other words, the optical coupling of the enhanced back-scattering fiber 555 with the telecom optical fiber 545 is not limited to one end or another of the telecom optical fiber 545, but the optical coupling can be positioned at any location within the telecom link (whether it be at one end, in the middle, or any other position along the telecom optical fiber 545).

Continuing with FIG. 5A, the system 500 comprises a transmitter 505, which, for purposes of this particular embodiment, is shown to be a 200 gigabit-per-second (200 Gb/s) 16 quadrature amplitude modulation (QAM) optical transmitter. The transmitter 505 is optically coupled to fiber amplifier 525 (shown as an erbium (Er) doped fiber amplifier (EDFA) or another type of gain-doped or rare-earth-doped amplifier) by a finite length of transmission fiber 515. An output of the amplifier 525 is optically coupled to the transmission fiber 545 via an optical isolator 535. On the other end of the fiber link, at the output of the enhanced scattering fiber 555, the system 500 comprises another optical isolator 565 and an optical amplifier 575, which convey the signal from the enhanced scattering fiber 555 to a demultiplexer (DeMux) 585. From the DeMux 585, the signal is provided to a receiver 595, which is shown as a 200 Gb, 16QAM receiver.

FIG. 5B shows an OTDR power 530 plotted as a function of fiber length 510 for the embodiment of the enhanced back-scattering fiber 555 of FIG. 5A, while FIG. 5C shows reflection and OSNR penalty at various wavelengths for the embodiment of the enhanced back-scattering fiber of FIG. 5A.

As shown in FIG. 5B, the Rayleigh scattering level of the bare fiber 545 pigtail is evident at the 0 km length (which represents the start 540 of the enhanced back-scattering fiber 555). Scattering enhancement 540 is half of the actual value because the y-axis values have been divided by 2 for the OTDR. As such, the level of enhancement should be doubled from the 9 dB increase that is shown in FIG. 5B.

FIG. 5C shows the spectrum 512 of a continuously enhanced scattering fiber 555 of length 10 km. The scattering bandwidth spans a wavelength (λ) range 502 (or bandwidth) of approximately 15 nm. For some embodiments, the wavelength range spans approximately 1535 nm to approximately 1549 nm, with R_{e,dB} fluctuating between approximately 15 dB and approximately 24 dB over a wavelength range of approximately 10 nm. Outside of the enhanced scattering bandwidth, at a center wavelength of approximately 1550 nm, the enhanced scattering fiber 555 exhibits a back-scatter that is close to that of an un-processed bare fiber (meaning, a bare fiber with no scattering enhancements applied). Consequently, the communication capacity of the out-of-band regions (meaning, outside of the enhanced scattering bandwidth) is shown to be similar to a standard transmission fiber (such as the ULL fiber 545). In a separate OTDR measurement, the attenuation at 1550 nm was measured to be 0.53 dB/km. One should note that the OTDR pulse for FIG. 5B has a large bandwidth that is close to the enhancement bandwidth shown in FIG. 5C. Thus, the level of enhancement shown in FIG. 5B is an average over that measured in FIG. 5C.

The bit-error-rate (BER) of 200 Gb/s 16QAM channels transmitted over the fiber link, as shown in FIG. 5A, was measured in conjunction with the OSNR penalty for different wavelength channels 522, 532, 542, 552, 562, 572. As shown in FIG. 5C, in-band scattering (meaning, within the enhanced scattering bandwidth) was as large as 24 dB over Rayleigh scattering, while out-of-band scattering (meaning, outside of the enhanced scattering bandwidth) was close to Rayleigh scattering or scattering in an unprocessed fiber (meaning, a fiber that has not been modified to enhance scattering). Signal penalties as a function of wavelength channels is also shown in FIG. 5C, with the penalty at the largest reflectivity being 6.7 dB, with the penalties falling to negligible levels in the out-of-band regions. Consequently, enhanced scattering can be confined to narrow bandwidths with little-to-no adverse effects on signal propagation, even in the presence of enhanced scattering.

As shown in this disclosure, the reach of telecom systems can be extended by using a combination of an enhanced scattering fiber (having a fixed bandwidth) with signal transmission outside of the enhanced scattering bandwidth. When desired or acceptable values for P_{min,dB} and SNR_{min,MPI} are provided, appropriate values for R_{e,dB} and α_{e,dB} permit configuration of enhanced scattering fibers to improve reach. If R_{e,dB} and α_{e,dB} vary linearly along the length of a fiber, then maximum reach is computable from four (4) parameters, namely, R_{e,dB}, the slope of R_{e,dB}, α_{e,dB}, and the slope of α_{e,dB}. Specifically, when a signal in an existing optical fiber has dropped to P_{min,dB}, adding an enhanced scattering fiber to the existing optical fiber of length z_{reach extension} will provide an extension in reach that is proportional to R_{e,dB} and inversely proportional to α_{e,dB} in the added enhanced scattering fiber. For an enhanced back-scattering fiber with a 10 dB enhanced scattering bandwidth over a 15 nm wavelength range, signals that are approximately mm outside of the enhanced scattering bandwidth can be transmitted with less than a 1 dB penalty in OSNR.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. An optical transmission system comprising:
a transmitter configured to transmit an optical telecom signal, the optical telecom signal having a telecom signal wavelength;
an optical amplifier optically coupled to the transmitter, the optical amplifier configured to amplify the optical telecom signal;
a telecom optical fiber suitable for telecommunications applications, the telecom optical fiber being longer than forty kilometers (40 km);
an enhanced scattering optical fiber optically coupled to the telecom optical fiber, the enhanced scattering optical fiber being configured to extend reach of the optical transmission system;
an in-band enhanced scattering region in the enhanced scattering optical fiber, the in-band enhanced scattering region having an enhanced scattering bandwidth, the in-band enhanced scattering region comprising an attenuation (α_{e,dB}), the in-band enhanced scattering region further comprising a back-scatter per unit length (ρₑ), the ρₑ being greater than Rayleigh scattering ρ_{R}, the in-band enhanced scattering region further comprising a back-scatter enhancement (R_{e,dB}), the R_{e,dB} being equal to 10·log₁₀(ρₑ/ρ_{R});
an out-of-band region in the enhanced scattering optical fiber, the out-of-band region comprising wavelengths that are outside of the enhanced scattering bandwidth, the telecom signal wavelength being in the out-of-band region, the out-of-band region exhibiting an out-of-band scattering, the out-of-band scattering being less than the ρₑ in the in-band enhanced scattering region, the out-of-band region configured to propagate the optical telecom signal; and
a receiver optically coupled to the enhanced scattering optical fiber, the receiver configured to receive the optical telecom signal.

2. The system of claim 1, the enhanced scattering bandwidth spanning a wavelength range of less than fifteen nanometers (15 nm).

3. The system of claim 1, the telecom signal wavelength being centered at approximately 1550 nanometers (nm).

4. The system of claim 3, the enhanced scattering bandwidth being between approximately 1535 nm and approximately 1549 nm.

5. The system of claim 1, the enhanced scattering optical fiber being further configured to extend the reach of the optical transmission system proportionally with R_{e,dB} and inversely with α_{e,dB}.

6. The system of claim 5, the R_{e,dB} being between approximately fifteen decibels (15 dB) and approximately 24 dB.

7. The system of claim 1, the out-of-band scattering being substantially the same as Rayleigh scattering.

8. The system of claim 1, the enhanced scattering optical fiber being greater than approximately 1 km in length.

9. An optical transmission system comprising:
a telecom optical fiber that exceeds forty kilometers (40 km) in length;
an enhanced scattering fiber optically coupled to the telecom optical fiber, the enhanced scattering fiber configured to extend reach of the optical transmission system;
an in-band enhanced scattering region in the enhanced scattering fiber, the in-band enhanced scattering region exhibiting an in-band enhanced scattering, the in-band enhanced scattering region having an enhanced scattering bandwidth, the in-band enhanced scattering being greater than Rayleigh scattering; and
an out-of-band region in the enhanced scattering fiber, the out-of-band region being outside of the enhanced scattering bandwidth, the out-of-band region being configured to propagate a telecom signal at a telecom signal wavelength, the out-of-band region exhibiting an out-of-band scattering that is less than the in-band enhanced scattering, the out-of-band region configured to propagate the optical telecom signal.

10. The system of claim 9, the in-band enhanced scattering region being a first in-band enhanced scattering region, the in-band enhanced scattering being a first in-band enhanced scattering, the enhanced scattering bandwidth being a first enhanced scattering bandwidth, the system further comprising:
a second in-band enhanced scattering region in the enhanced scattering fiber, the second in-band enhanced scattering region being different than the first in-band enhanced scattering region, the second in-band enhanced scattering region exhibiting a second in-band enhanced scattering, the second in-band enhanced scattering region having a second enhanced scattering bandwidth, the second in-band enhanced scattering being greater than Rayleigh scattering.

11. The system of claim 9, the enhanced scattering bandwidth spanning a wavelength range of less than fifteen nanometers (15 nm).

12. The system of claim 9, the telecom signal wavelength being centered at approximately 1550 nanometers (nm).

13. The system of claim 12, the enhanced scattering bandwidth being between approximately 1535 nm and approximately 1549 nm.

14. The system of claim 9, the in-band enhanced scattering region comprising an attenuation (α_{e,dB}), the in-band enhanced scattering region further comprising a back-scatter per unit length (ρₐ), the ρₑ being greater than Rayleigh scattering ρ_{R}, the in-band enhanced scattering region further comprising a back-scatter enhancement (R_{e,dB}), the R_{e,dB} being equal to 10·log₁₀(ρₑ/ρ_{R}).

15. The system of claim 14, the enhanced scattering optical fiber being further configured to extend the reach of the optical transmission system proportionally with R_{e,dB} and inversely with α_{e,dB}.

16. The system of claim 14, the R_{e,dB} being between approximately fifteen decibels (15 dB) and approximately 24 dB.

17. The system of claim 9, the out-of-band scattering being substantially the same as Rayleigh scattering.

18. The system of claim 9, the out-of-band scattering being substantially the same as scattering in an unprocessed fiber.

19. The system of claim 9, the enhanced scattering optical fiber being greater than approximately 1 km in length.

20. The system of claim 9, the telecom signal wavelength being at least one nanometer (1 nm) outside of the enhanced scattering bandwidth.
